(19) United States
(12) Patent Application Publication
(10) Pub. No.: US 2019/0309745 A1
(43) Pub. Date: Oct. 10, 2019

(54) Screw Compressor for a Utility Vehicle

(71) Applicants: Tamas ADLER, München (DE); Huba NÉMETH, München (DE); Viktor TIHANYI, München (DE); KNORR-BREMSE Systeme fuer Nutzfahrzeuge GmbH, Muenchen (DE)

(72) Inventors: Tamas ADLER, Muenchen (DE); Huba NEMETH, Muenchen (DE); Viktor TIHANYI, Muenchen (DE)

(21) Appl. No.: 16/333,154

(22) PCT Filed: Sep. 19, 2017
(86) PCT No.: PCT/EP2017/073554

§ 371 Date: May 31, 2019

(30) Foreign Application Priority Data
Sep. 21, 2016 (DE) 10 2016 011 502.5

(51) Int. Cl. F04B 49/06; F04C 18/16; F04B 41/02; B60T 17/02; F04B 35/04; B60T 17/22; F04C 28/28; B60T 17/00; B60T 13/66; B01D 53/26; B01D 53/04

(52) U.S. Cl. CPC F04B 49/065; F04C 18/16; F04B 41/02; B60T 17/02; F04B 35/04; F04B 2203/0209; F04C 28/28; B60T 17/004; B60T 13/665; B01D 53/26; B01D 53/0454; B60T 17/228

(57) ABSTRACT

A compressor system for an utility vehicle includes at least one compressor, at least one electric motor which drives the compressor, at least one electric motor control unit and at least one air treatment device. The electric motor control unit is designed and configured in such a way that it controls the electric motor and at least partly the air treatment device.

### BACKGROUND AND SUMMARY OF THE INVENTION

The present invention relates to a compressor system for a utility vehicle comprising at least one compressor, at least one electric motor and at least one air processing device.

Air processing systems for utility vehicles are already known from the prior art.

Air processing systems for utility vehicles are usually composed of a plurality of main components such as air compressor, air processing unit and a plurality of compressed air accumulators.

The use of electronic control devices for air processing devices (or Electronic Control for Air Processing Units (E-APU)) in utility vehicles has already existed for a relatively long time. Systems of this kind provide pressure control, air drying control and circuit protection functions.

For pressure control and circuit protection functionalities, these systems use different pressure sensors in order to control and to monitor the pressure level and do so in various circuits of the compressed air system of a utility vehicle. A plurality of solenoid valves are used in order to provide regeneration and compressor control functionalities.

Control for the air processing unit, which exists in addition to said functionalities, can be integrated into the so-called air processing units too.

Also known are a plurality of systems in which control for the air processing unit is not integrated but rather in which said control is formed as an external solution, so that only the actuators and pressure sensors are accommodated in the air processing unit.

A control device of this kind is known, for example, from DE 10 2011 107 155 A1.

The object of the present invention is to develop a compressor system for a utility vehicle of the kind mentioned in the introductory part in an advantageous manner, in particular to the effect that the compressor system for a utility vehicle can be constructed in a more simple manner and can be configured so as to be more efficient.

According to the invention, this object is achieved by a compressor system for a utility vehicle having at least one compressor, at least one electric motor which drives the compressor, at least one electric motor control unit and at least one air processing device, wherein the electric motor control unit is designed and configured in such a way that it controls the electric motor and, at least partially, the air processing device.

The invention is based on the basic idea of integrating both the control functionality for the compressor and for the air processing device in the electric motor control unit by function integration in the electric motor control unit. As a result, it is possible to furnish the existing powerful electric motor control unit with further functionalities, so that a further control unit for the air processing device can be dispensed with.

Furthermore, provision can be made for the compressor to be a screw compressor. This results in the advantage that efficient and powerful compressed air provision by means of a screw compressor is possible. Screw compressors have, particularly in new fields of application such as hybrid utility vehicles, great advantages since they can be operated more efficiently than existing compressors which involve the drive assembly of the utility vehicle being continuously operated. However, this is no longer the case in hybrid utility vehicles.

Furthermore, provision can be made for the air processing device to have a multi-circuit protection valve and a plurality of compressed air accumulators. These functionalities can likewise be monitored and actuated by the electric motor control unit too.

Provision can also be made for the electric motor control unit to have signal inputs which are designed and configured in such a way that they serve to process the sensor signals of the air processing device. These signal inputs can have the effect, in a simple manner, that the electric motor control unit and the air processing device can communicate with one another. To this end, provision is particularly made for the electric motor control unit to be provided with the appropriate, standardized or industry-standard connections or signal connections.

The electric motor control unit can have signal outputs which are designed and configured in such a way that they serve to drive actuators of the air processing unit. Therefore, it is possible for the air processing device to be able to be actuated in a corresponding manner, wherein, in the case of the actuators, in particular the solenoid valves or other valves of the air processing device are to be actuated. Efficient operation of the air processing device is possible as a result of this.

Furthermore, provision can be made for the electric motor control unit to have a pressure monitoring control module which is designed and configured in such a way that the pressure in the air processing device can be monitored and/or can be regulated by means of the pressure monitoring control module. As a result, it is possible to monitor and to regulate significant functionalities of the air processing device, specifically in respect of the pressure prevailing in the air processing device and in particular the operating pressure prevailing there. On the basis of this monitoring, it is possible to be able to operate the air processing device in an efficient and effective manner and accordingly to monitor and to regulate said air processing device by means of the electric motor control unit by way of its pressure monitoring control module.

Furthermore, provision can be made for the pressure monitoring control module to be further designed and configured in such a way that the pressure in at least one further compressed air consumer of the utility vehicle can be monitored and/or can be regulated by means of the pressure monitoring control module. As a result, it is possible to be able to provide corresponding monitoring and regulation by the pressure monitoring control module of the electric motor control unit in other parts of the compressed air system of the utility vehicle as well, and not only in the air processing device.

Furthermore, provision can be made for the electric motor control unit to have an air drying control module which is designed and configured in such a way that the air drying function in the air processing device can be monitored and/or can be regulated by means of the air drying control module. As a result, it is possible to be able to monitor and regulate a further important functionality of the air processing device.

It is also conceivable for the electric motor control unit to have a rotation speed control module which is designed and configured in such a way that the rotation speed of the electric motor can be controlled and/or can be regulated by means of the rotation speed control module. By means of regulating the rotation speed, the power consumption of the electric motor and also the operation of the electric motor can be accordingly controlled and also adjusted. This can be done in accordance with the loading and directly.

Further details and advantages of the invention will now be explained in more detail with reference to an exemplary embodiment which is illustrated in the drawings.

### BRIEF DESCRIPTION OF THE DRAWINGS

FIG. 1 shows a schematic view of an air processing device for a utility vehicle; and

FIG. 2 shows a perspective arrangement of the exemplary embodiment according to FIG. 1.

### DETAILED DESCRIPTION OF THE DRAWINGS

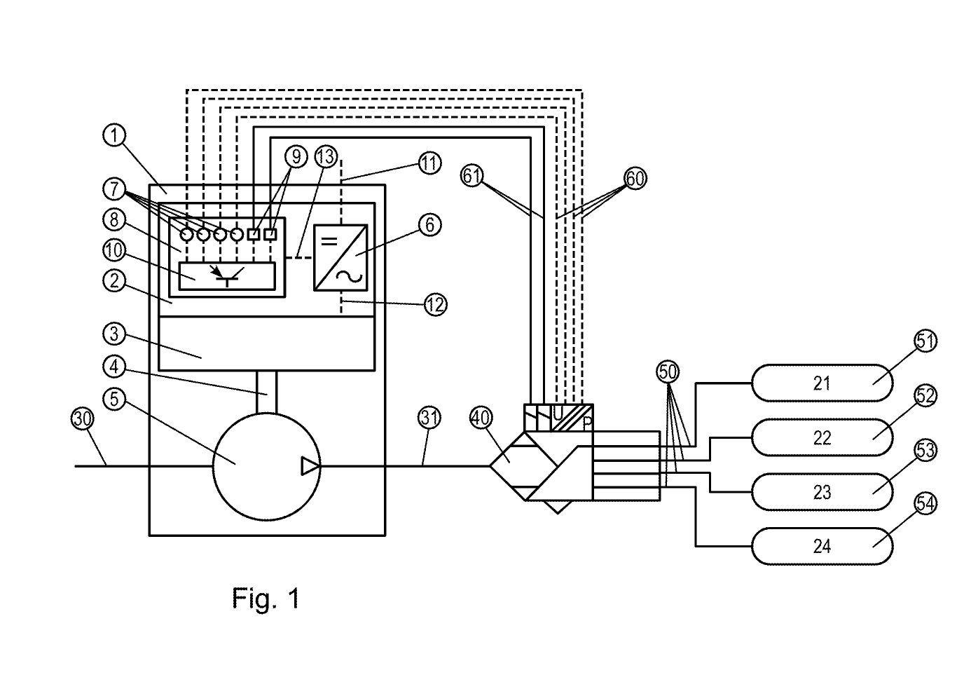

FIG. 1 shows a schematic drawing of a utility vehicle air processing system comprising a compressor 5 which is driven by an electric motor 3.

Driving of the compressor 5 by means of the electric motor 3 takes place via a common drive shaft 4 and an electric motor control unit 2. All of these components are arranged in a common housing 1.

The compressor 5 is a screw compressor 5.

Furthermore, the air processing unit 40 which has a multi-circuit protection valve and a plurality of compressed air accumulators 51-54 with compressed air 21-24 stored therein is present.

The compressor 5 receives ambient air through the intake line 30, and the outlet is connected to the air processing unit 40 via an air outlet line 31.

The following constituent parts are integrated in the electric motor control unit 2: the control unit 10 for the air processing device 40 (A.10) and the control unit 10 for the frequency unit converter 6 for the electric motor 3, which control units are connected to one another via an electrical control line 30.

The frequency converter 6 has an energy connection 11 and its output is connected to the electric motor 3 via a corresponding electrical line 12.

The electric motor control unit 2 is equipped with corresponding signal inputs 7 (analog signal inputs 7) for receiving pressure sensor signals and the connections to the solenoid valves 9 in order to be able to monitor all of the functions of the air processing unit 40 and also the activity of the various pneumatic loads 50 of the utility vehicle.

The analog signal inputs 7 of the electric motor control unit 2 are connected to the air processing device 40 by means of electrical connections 60.

The same applies for the valve drives 9 which are likewise accordingly connected via connection lines 61.

The integrated control unit 2 is able to control and to actuate the frequency converter 6 of the electric motor 3 and also all of the functions of the air processing device 40, for which purpose the signal inputs 7 and signal outputs 9 are used.

With the aid of these connections 7 and 9, it is possible to be able to accordingly control the pressure situation in the air processing device 40 and the air drying function.

Furthermore, it is possible to accordingly monitor the vehicle status, the electric motor status and also the air treatment status and to output a corresponding rotation speed to the electric motor 3 in order to be able to provide an optimum and best-possible operating characteristic for the compressor 5.

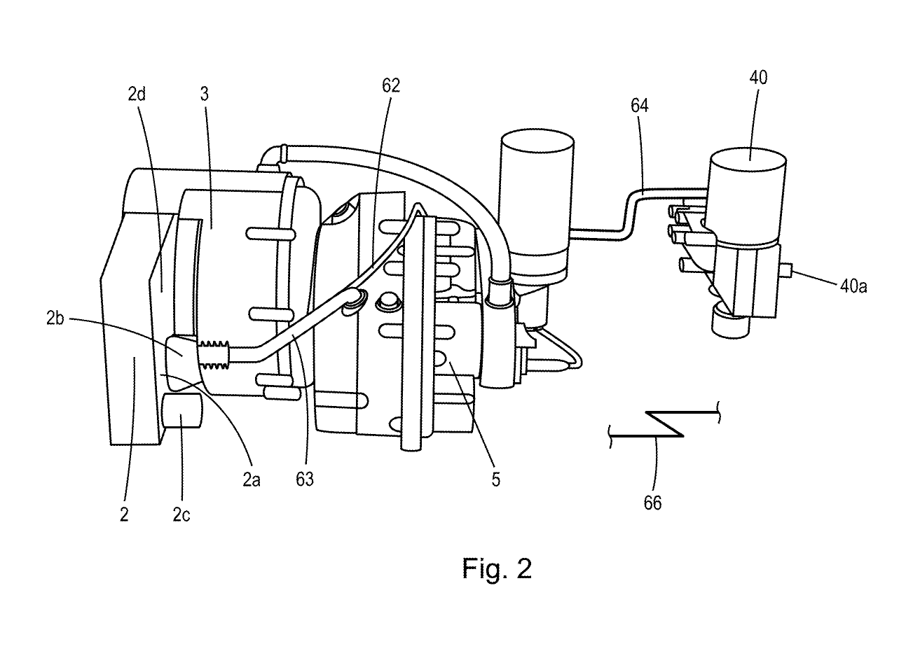

FIG. 2 shows, in a perspective view, the utility vehicle air processing system shown in FIG. 1 comprising the compressor 5 which is driven by the electric motor 3.

FIG. 2 also shows the air processing unit 40 and the associated (compressed air) air supply line 64.

In this case, the electric motor control unit 2 is arranged directly on the electric motor 3.

In this case, the electric motor control unit 2 has two data cable connections 2a and 2b.

A power connection 2c is also provided.

The electric motor control unit 2 also has a connection 2d for connection to, for example, the CAN bus of a utility vehicle.

A first data cable 62 is connected to the data cable connection 2a.

The electric motor control unit 2 is connected in a signal transmitting manner to the electric motor 3 by means of the data transmission cable 62.

In the exemplary embodiment shown, the data transmission cable 62 is connected to an oil level sensor of the screw compressor 3 and serves to transmit oil level sensor data to the electric motor control unit 2.

A second data cable 63 is connected to the data cable connection 2a.

The electric motor control unit 2 is also connected in a signal transmitting manner to the electric motor 3 by means of the data transmission cable 63.

In the exemplary embodiment shown, the data transmission cable 63 is connected to a temperature sensor of the screw compressor 3 and serves to transmit temperature sensor data to the electric motor control unit 2.

In principle, other sensors can also be connected to the electric motor control unit 2 by means of the data transmission cables, and corresponding operating data of the screw compressor 3 can be transmitted.

Furthermore, the electric motor control unit 2, which is an integral constituent part of the electric motor 3, is connected to the data bus 66 of the utility vehicle by means of the connection.

In the exemplary embodiment shown, the data bus 66 here is a CAN bus which is the CAN bus of the utility vehicle.

The communication between the electric motor control unit 2, which is a constituent part of the electric motor 3, and the air processing unit 40 therefore takes place by means of the CAN bus 66.

The air processing unit 40 has a connection 40a for connection to the CAN bus 66.

The use of the CAN bus 66 has the effect that the signal transmission is less susceptible to faults and also fewer interference signals can occur.

In particular, it is possible to operate with considerably shorter lines for signal transmission from the electric motor control unit 2 to the CAN bus 66 and from the CAN bus 66 to the air processing unit 40, as a result of which function integration and also use of the existing signal transmission infrastructure of the utility vehicle that is present in any case are possible.

As is clear from FIG. 1 and FIG. 2, the electric motor 3, the screw compressor 5 and also the air processing unit 40 are independent units.

However, both the electric motor 3 and the air processing unit 40 are actuated by the electric motor control unit 2 of the electric motor 3.

There is therefore function integration of the control and regulation for the screw compressor 5 and the air processing 40 in the control unit 2 of the electric motor 3, which control unit has to be provided with a powerful control and regulation unit in any case.

Therefore, expensive electronic components can be saved, specifically in particular in the region of the screw compressor 5, but also in the region of the air processing unit 40, here.

Particularly advantageous signal transmission for actuation of the air processing unit 40 by the electric motor control unit 2 is further rendered possible owing to the use of the signal transmission bus, here the CAN bus 66.

### LIST OF REFERENCE SYMBOLS

1 Housing
2 Electric motor control unit
2a Data cable connection
2b Data cable connection
2c Power connection
2d Connection
3 Electric motor
4 Drive shaft
5 Compressor
6 Frequency unit converter
7 Signal inputs
9 Solenoid valve
10 Control unit
11 Energy connection
12 Electrical line
21 Compressed air
22 Compressed air
23 Compressed air
24 Compressed air
30 Intake line/control line
31 Air outlet line
40 Air processing unit
40a Connection
50 Pneumatic load
51 Compressed air accumulator
52 Compressed air accumulator
53 Compressed air accumulator
54 Compressed air accumulator
60 Electrical connections
61 Connection lines
62 Data transmission cable
63 Data transmission cable
64 (Compressed air) air supply line
65 Data bus, CAN bus

1-9. (canceled)

10. A compressor system for a utility vehicle, comprising:
at least one compressor;
at least one electric motor which drives the compressor;
at least one electric motor control unit; and
at least one air processing device, wherein
the electric motor control unit is configured so as to control the electric motor and, at least partially, the air processing device.

11. The compressor system as claimed in claim 10, wherein
the compressor is a screw compressor.

12. The compressor system as claimed in claim 10, wherein
the air processing device has a multi-circuit protection valve and a plurality of compressed air accumulators.

13. The compressor system as claimed in claim 10, wherein
the electric motor control unit has signal inputs which are configured so as to serve to process sensor signals of the air processing device.

14. The compressor system as claimed in claim 10, wherein
the electric motor control unit has signal outputs which are configured so as to serve to drive actuators of the air processing device.

15. The compressor system as claimed in claim 10, wherein
the electric motor control unit has a pressure monitoring control module which is configured such that pressure in the air processing device is monitorable and/or regulatable by the pressure monitoring control module.

16. The compressor system as claimed in claim 15, wherein
the pressure monitoring control module is further configured such that the pressure in at least one further compressed air consumer of the utility vehicle is monitorable and/or regulatable by the pressure monitoring control module.

17. The compressor system as claimed in claim 10, wherein
the electric motor control unit has an air drying control module which is configured such that the air drying function in the air processing device is monitorable and/or regulatable by the air drying control module.

18. The compressor system as claimed in claim 10, wherein
the electric motor control unit has a rotation speed control module which is configured such that a rotation speed of the electric motor is controllable and/or regulatable by the rotation speed control module.
